(19) United States
(12) Patent Application Publication
(10) Pub. No.: US 2023/0267294 A1
(43) Pub. Date: Aug. 24, 2023

(54) ADJUSTING COLORANT VALUES IN IMAGES TO BE PRINTED

(71) Applicant: Hewlett-Packard Development Company, L.P., Spring, TX (US)

(72) Inventors: Marcos CASALDALIGA ALBISU, Sant Cugat del Valles (ES); Maurizio BORDONE, Sant Cugat del Valles (ES); Li QIAN, Sant Cugat del Valles (ES); Carles CARMONA CALPE, Sant Cugat del Valles (ES)

(73) Assignee: Hewlett-Packard Development Company, L.P., Spring, TX (US)

(21) Appl. No.: 18/004,063

(22) PCT Filed: Jul. 2, 2020
(86) PCT No.: PCT/US2020/040594

§ 371 Date: Jan. 2, 2023

(51) Int. Cl. G06K 15/02; G06K 15/00; B41J 2/205; B41J 2/21

(52) U.S. Cl. CPC G06K 15/188; G06K 15/408; B41J 2/2056; B41J 2/2132

(57) ABSTRACT

A colorant value adjustment method is disclosed. The method comprises obtaining data defining colorant values for a plurality of print addressable locations representative of pixels of an image to be printed during a printing operation, wherein each colorant value is representative of an amount of colorant to be delivered from a print nozzle to a corresponding print addressable location as the print nozzle moves between the print addressable locations during the printing operation. The method comprises determining, based on the obtained data, a measure of time that the print nozzle is not to deposit colorant immediately prior reaching a first print addressable location. The method comprises determining, based on the determined measure of time, an adjustment to be applied to the colorant value at the first print addressable location. The method comprises applying the adjustment to the colorant value for the first print addressable location. An apparatus and a machine-readable medium are also disclosed.

### BACKGROUND

In some print apparatuses, print agent is deposited from a nozzle of a print head onto a printable substrate, as the print head and the printable substrate move relative to one another. When an image to be printed includes a region in which no print agent is to be deposited, then the print head may move relative to the printable substrate without depositing any print agent.

If a nozzle of a print head goes some time without depositing print agent, then characteristics of print agent in the nozzle and/or in the print head may change.

### BRIEF DESCRIPTION OF DRAWINGS

Examples will now be described, by way of non-limiting example, with reference to the accompanying drawings, in which:

FIG. 1 is a schematic illustration of an example of part of a print apparatus during a printing operation;

FIG. 2 is a flowchart of an example of a method of adjusting colorant values;

FIG. 3 is a flowchart of a further example of a method of adjusting colorant values;

FIG. 4 is a schematic illustration of an example of an apparatus for adjusting colorant values;

FIG. 5 is a schematic illustration of a further example of an apparatus for adjusting colorant values; and

FIG. 6 is a is a schematic illustration of an example of a processor in communication with a computer medium.

### DETAILED DESCRIPTION

Some print apparatuses deposit print agent or printing fluid, such as ink, from a nozzle or nozzles of a print head onto a printable substrate (e.g. paper, cardboard, ceramics, textiles, fabric or the like) as one or both of the print head and the printable substrate are moved relative to one another. For example, a printhead or multiple print heads may be mounted on or in a carriage that scans across the printable substrate as the printable substrate is moved in a substrate advance direction. This process may be referred to as a printing operation. Print agent may be deposited from particular nozzles at particular times according to image data relating to or defining a source image to be printed during a printing operation. A nozzle of a print head may deposit print agent of a single color, for example to prevent cross contamination between colors.

If the image data of a source image to be printed indicates that print agent is not to be deposited onto a particular region of the printable substrate, then print agent is not deposited from the relevant nozzle or nozzles, and print agent may therefore remain in the nozzle or in a channel via which print agent is supplied to the nozzle. If a nozzle goes a period of time without depositing print agent, then changes may occur to the print agent remaining in the nozzle or channel. In some cases, water in the print agent may evaporate from print agent in the nozzle and/or in the channel as a result of thermal energy in the print head transferring to the print agent. As water evaporates, the print agent may be left with a relatively higher concentration of dye and solvent, resulting in the print agent having a darker color. As a consequence, print agent from which water has been evaporated may appear on the printable substrate to be dark in color than print agent deposited from the same nozzle from which water has not evaporated. During a printing operation, therefore, the first drops of print agent deposited from a nozzle following a period during which no print agent has been deposited from the nozzle may appear darker than intended, leading to image quality defects in the printed image.

The changes occurring in print agent remaining in nozzles and channels that do not deposit print agent for a period of time may be referred to as dye enrichment. Such changes may occur in any type of print agent or print fluid, and may occur, for example, in a type of print agent referred to as dye sublimation ink.

Examples disclosed herein provide a mechanism by which changes may be made to image data defining the image to be printed in advance of, or during, the printing operation, such that an amount of print agent to be deposited at a particular location of the image can be varied (e.g. reduced) if print agent to be deposited at that location is likely to suffer from the above-mentioned effects. For example, if, based on the image data defining the image to be printed, it can be determined that a particular nozzle is to deposit print agent following a period of not depositing print agent, then it may be expected that the print agent will have undergone changes (e.g. dye enrichment) and the print agent may therefore be likely to appear darker in the printed image. Therefore, to reduce the effect of such a change in the print agent color, the image data may be adjusted such that the amount of print agent to be deposited at the particular location where the effect is likely to be evident is reduced before the nozzle deposits print agent at that particular location. In this way, image quality defects resulting from differences from the intended color of print agent (e.g. due to dye enrichment) in a printed image may be reduced or even avoided.

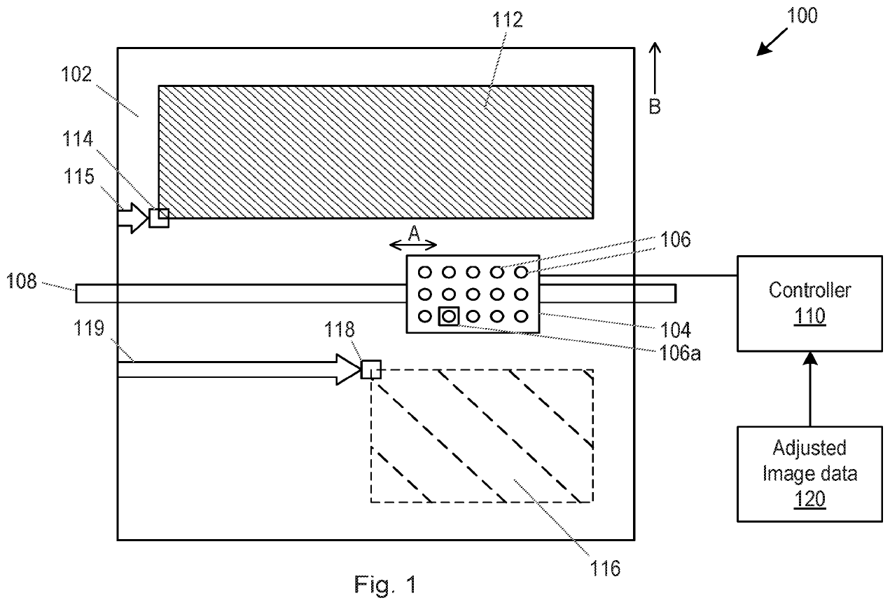

Referring to the drawings, FIG. 1 is a schematic illustration of an example of part of a print apparatus 100 depositing print agent onto a printable substrate 102 during a printing operation. The print apparatus 100 includes a print head 104 having a plurality of nozzles 106 from which print agent may be fired or deposited onto the printable substrate 102. In the example shown in FIG. 1, just a few nozzles 106 are shown. However, depending on the print apparatus 100, the number of printheads 104 and/or the number of nozzles 106 may vary. For example, each printhead 104 may include hundreds or thousands of nozzles 106. In the example shown, the print head 104 may be mounted on or in a carriage (not shown) and may be capable of scanning across a width of the printable substrate 102 along a beam 108. During a printing operation, the print head 104 may move in a direction indicated by double-headed arrow A. The printable substrate 102 may be advanced (e.g. by a substrate advance mechanism, not shown) in a substrate advance direction indicated by arrow B. In some examples, print colorant or print agent may be deposited at a particular print addressable location during multiple passes over the printable substrate 102 by the print head 104.

Operation of the print head 104, the substrate advance mechanism and other components (e.g. components that cause firing of print agent from the nozzles 106) may be controlled by a controller 110, which may for example comprise processing circuitry, a processor or multiple processors. Prior to performing a printing operation, the controller 110 may receive image data defining an image to be printed, and the controller may operate the components of the print apparatus 100 to cause print agent to be deposited onto the printable substrate 102 in accordance with the image data. Individual picture elements that together make up an image to be printed may be referred to as pixels. In some examples herein, locations (e.g. on the printable substrate 102) that correspond to pixels in the image to be printed may be referred to as print addressable locations. A nozzle or multiple nozzles 106 of the print head 104 may deposit print agent at particular print addressable locations in accordance with the image data defining the image to be printed.

In FIG. 1, an example of an image being printed during a printing operation is shown on the printable substrate 102. In this example, a first region 112 of print agent has been printed on the printable substrate 102. A box 114 indicates the position of one print addressable location to be printed in the first region 112 by a particular nozzle 106a of the print head 104. In some examples, before performing a pass over the printable substrate 102 to deliver print agent, nozzles (e.g. the nozzle 106a) of the print head 104 may deposit print agent (e.g. a drop or multiple drops) in a servicing or spitting area. This may help to bring the nozzles to an intended temperature for printing, and may be performed in an area either side of the printable substrate 102. Following the depositing of print agent in the servicing area, the nozzle 116a may move a distance indicated by the arrow 115 before it delivers print agent at the print addressable location indicated by the box 114. The time taken for the nozzle to travel the distance indicated by the arrow 115 may be referred to as an idle time of the nozzle. A box 116 indicates a location on the printable substrate 102 where a second region is to be printed, and a box 118 indicates the position of one print addressable location to be printed in the second region by the particular nozzle 106a. Following the depositing of print agent in the servicing area, the nozzle 116a may move a distance indicated by the arrow 119, which is larger than the distance indicated by the arrow 115, before it delivers print agent at the print addressable location indicated by the box 118. It will be understood that the nozzle 106a is merely an example of a nozzle of the print head 104 that may deposit print agent at the print addressable locations 114 and 118, and that the image being printed in the example shown in FIG. 1 is merely one example of any image that may be printed.

Between depositing print agent in the servicing area beside the printable substrate 102, and depositing print agent at the print addressable locations 114 of the first region 112 and depositing print agent at the first print addressable location 118 of the second region 116, a period of time will elapse while the print head 104 scans across a portion of the printable substrate (i.e. indicated by the arrows 115 and 119). During this time, no print agent will be deposited from the nozzle 106a. As a result, print agent remaining in the nozzle 106a may undergo changes, such as those discussed above, including dye enrichment.

According to examples of the present disclosure, in order to prevent print agent that is deposited at the print addressable locations 114, 118 from appearing relatively darker than intended, a change or adjustment may be made to the image data provided to the controller 110 such that less print agent is deposited at any print addressable location following an idle time (e.g. which may lead to the print agent being affected by dye enrichment) than was indicated in the originally-provided image data. Thus, the image data defining the image to be printed may be processed to adjust an intended amount of print agent that is to be deposited at any print addressable locations where it is expected that dye enrichment will occur as a result of no print agent being deposited from a nozzle (e.g. the nozzle 106a) for a period of time before reaching those print addressable locations. Adjusted image data 120 (e.g. including the original image data and any appropriate adjustments) may be provided to the controller 110, and the controller may operate the print apparatus 102 print an image in accordance with the adjusted image data.

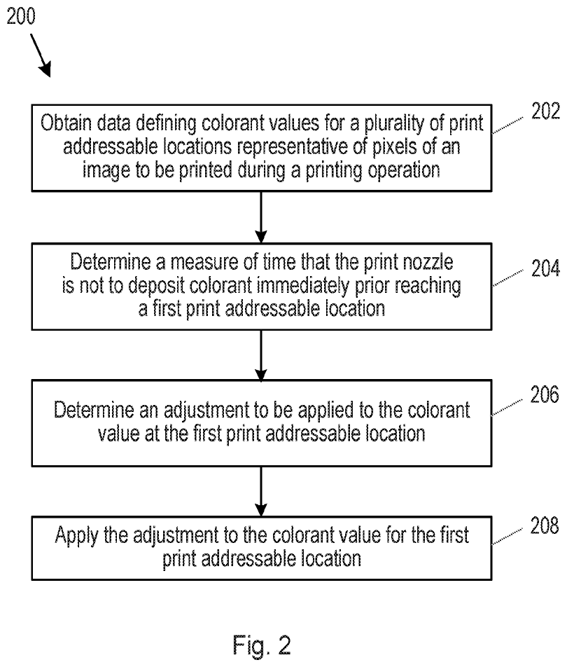

The present disclosure provides a method. FIG. 2 is a flowchart of an example of a method 200. The method 200 may, in some examples, comprise a computer-implemented method performed by a processor or appropriate processing circuitry. In some examples, the method 200 may be considered to be a method of adjusting colorant values. The method 200 comprises, at block 202, obtaining data defining colorant values for a plurality of print addressable locations representative of pixels of an image to be printed during a printing operation. Each colorant value is representative of an amount of colorant to be delivered from a print nozzle to a corresponding print addressable location as the print nozzle moves between the print addressable locations during the printing operation. The obtained data may comprise image data defining an image to be printed. In some examples, the colorant values may comprise continuous tone values, sometimes referred to as contone values. A contone value may for example comprise one of a plurality of discrete steps or values representing an amount of a particular color that makes up the intended color of a pixel of an image. For example, each pixel of the image to be printed may have a corresponding contone value ranging between 0 and 255 for each color of print agent that is to be delivered in the corresponding print addressable location. Thus, the data defining the colorant values may comprise a matrix representation that includes a colorant value, or contone value corresponding to each pixel in the image to be printed.

At block 204, the method 200 comprises determining, based on the obtained data, a measure of time that the print nozzle is not to deposit colorant immediately prior reaching a first print addressable location. The determining of block 204 may be performed by analyzing the obtained data. In some examples, parameters of the print apparatus and/or the print agent or colorant being used may be taken into account when determining the measure of time. For example, the type of print agent or colorant may affect the amount of color change that occurs when a nozzle 106 goes a period of time without depositing colorant onto the printable substrate 102. Similarly, the print apparatus may be operated in a different way depending on the type of print agent used. Depending on the type of print apparatus, the print head 104 may print in just one direction (e.g. while it scans in one direction over the printable substrate 102), or in both directions. In some examples, the type of print apparatus may affect the speed at which the print head 104 travels between print addressable locations. The speed at which the print head 104 travels over the printable substrate 102 between print addressable locations may affect the idle time of the nozzle between print addressable locations to be printed. Therefore, the measure of time may be determined (at block 204) based on: i) a distance between the first print addressable location and a second print addressable location at which the print nozzle is to deliver colorant immediately prior to reaching the first print addressable location, and ii) a speed at which the print nozzle is to move between the second print addressable location and the first print addressable location.

By considering which pixels are to be printed when and by which nozzles of the print head 104, it is possible to determine when a particular nozzle will go a period of time without depositing print agent and how long the nozzle will go without depositing print agent. This can be done for each pixel of the image to be printed so that it is possible to establish an effect (e.g. an image quality print defect) that is likely to occur at each print addressable location as a result of the nozzle not printing (i.e. remaining idle) for a period of time. In practice, each pixel may be analyzed in advance and processed in the manner described herein to adjust the colorant value, or processing may be done on the fly, when it is determined that the nozzle has been, or will be, idle for a given time prior to reaching a print addressable location. This may be done for each print addressable location in the image.

The method 200 comprises, at block 206, determining, based on the determined measure of time, an adjustment to be applied to the colorant value at the first print addressable location. Thus, once a nozzle's idle time prior to reaching a particular print addressable location has been determined, the likely effect of that idle time can be determined and, therefore, the suitable adjustment or correction can be determined to compensate for the effect of the idle time. For example, the colorant value (e.g. contone value) and a particular print addressable location might be 50. However, it may be determined at block 204 that a nozzle 106 to deposit print agent or colorant at that print addressable location has an idle period (i.e. a period during which no print agent is deposited from the nozzle) of 0.5 seconds, for example, immediately prior to reaching the print addressable location. It may be determined (empirically, for example) that, as a result of such an idle period in this particular print apparatus, the color of the print agent or colorant deposited at the particular print addressable location will appear darker, corresponding to a colorant value of 55, rather than 50. Therefore, to compensate for the change that is expected to occur, it may be determined at block 206 that the colorant value at that particular print addressable location should be reduced to 45.

In some examples, print addressable locations outside the image to be printed may also be taken into account when determining whether or not a nozzle has gone a period of time without depositing colorant or print agent. For example, a nozzle may deposit (e.g. spit or fire) colorant within a servicing region, such as a spitting region or nozzle cleaning region (e.g. a spitbar) before or during a printing operation, for example between passes over the image. Deposits made at these locations may be taken into account.

At block 208, the method 200 comprises applying the adjustment to the colorant value for the first print addressable location. Blocks 204, 206 and 208 may be repeated for each print addressable location, such that the current values of any printed addressable locations that are likely to be affected by dye enrichment can be adjusted prior to the printing operation, so that the print agent deposited during printing operation is of the intended color.

In some examples, the image data obtained at block 202 may include, or may be used to derive, data indicative of a number of passes of the print head 104 over the printable substrate 102 to deposit the appropriate amount of colorant or print agent at each print addressable location. For example, the amount of colorant defined by the colorant value for a print addressable location may be deposited over a plurality of passes over that print addressable location by the print head 104. The number of passes to be performed may depend on a print mode of the print apparatus, or on the nature of the print apparatus itself. The number of passes may be a parameter that is provided to as part of the method 200, or derived from the image data and used as part of the method, to make the determinations in blocks 204 and 206.

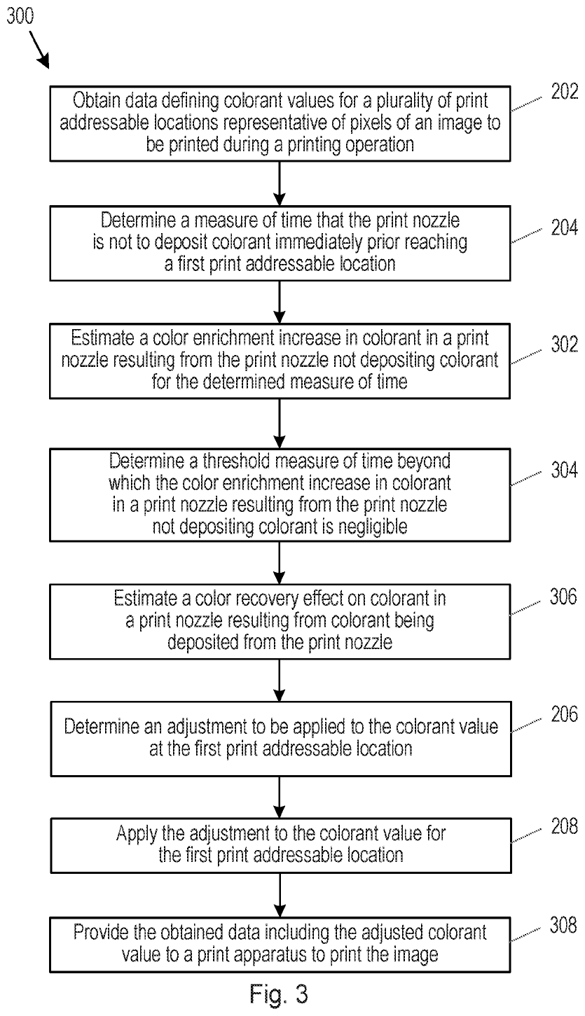

FIG. 3 is a flowchart of a further example of a method 300. The method 300 may comprise a computer-implemented method and/or may be considered to be a method of adjusting colorant values. The method 300 may comprise a block or blocks of the method 200 discussed above. In some examples, the method 300 may comprise, at block 302, estimating a color enrichment increase in colorant in a print nozzle resulting from the print nozzle not depositing colorant for the determined measure of time. The estimation performed at block 302 may, for example, be performed following block 204. The color enrichment increase may vary as a function of the nozzle idle time (i.e. as a function of the time that the print nozzle does not deposit colorant or print agent) immediately prior to reaching the particular print addressable location. Thus, the color enrichment increase may be considered to vary as a function of a distance that the print nozzle travels between print addressable locations where the print nozzle is to deposit colorant. With knowledge of the print apparatus and, in particular, the speed at which the print head 104 travels over the printable substrate 102, the idle time of the nozzle can be determined based on knowledge of the distance between print addressable locations to be printed. In some examples, the color enrichment increase may be referred to as a color enrichment gain, or a dye enrichment gain. The color enrichment increase may be represented or expressed as a function, and may be referred to as a color enrichment increase function. In some examples, the color enrichment increase function may be approximated as a linear function and may therefore be represented by a value.

In examples where a color enrichment increase in colorant is estimated (block 302), determining the adjustment (at block 206) may be based further on the estimated color enrichment increase.

As noted above, the effect of a nozzle remaining idle for a given period of time may be determined empirically. In some examples, the color enrichment increase over a given period of time may also be determined empirically. For example, the color enrichment increase and other effects may be determined empirically for a given print apparatus and/or for a given type or color of colorant.

As noted above, the color enrichment may increase as a function of the time for which a particular nozzle remains idle. However, in some examples, the color enrichment occurring in colorant in a particular nozzle may reach a threshold after a given idle time. Beyond the threshold color enrichment, any change in color of the colorant may be negligible with increasing time. Thus, there may exist a threshold idle time beyond which any change in color of print agent remaining in the nozzle is negligible (e.g. less than a defined change threshold). In some examples, therefore, any adjustment determined at block 206 may take into account the threshold idle time and, if it is determined that a particular nozzle is to remain idle beyond the threshold idle time, then further adjustment of the colorant value may not be made.

Thus, at block 304, the method 300 may comprise determining a threshold measure of time beyond which the color enrichment increase in colorant in a print nozzle resulting from the print nozzle not depositing colorant is negligible. In some examples, the threshold measure of time may correspond to a ‘maximum color enrichment increase’. Determining the adjustment (block 206) may be based further on the determined threshold measure of time. In other words, the adjustment determined at block 206 may have an upper limit corresponding to the threshold measure of time, or threshold idle time.

Once colorant begins to be deposited from a nozzle following a period of idle time, the amount of affected colorant remaining in the nozzle reduces. Thus, as colorant is gradually deposited from the nozzle, the color enrichment may be considered to decrease until all of the affected colorant has been deposited from the nozzle, and the colorant that is deposited from the nozzle thereafter is of the intended color. The decrease in color enrichment may be referred to as a color recovery, or dye enrichment recovery, since the intended color of the colorant is recovered. The method 300 may comprise, at block 306, estimating a color recovery effect on colorant in a print nozzle resulting from colorant being deposited from the print nozzle. As noted above, the color recovery effect may, therefore, comprise a decrease in color enrichment. Determining the adjustment (at block 206) may be based further on the estimated color recovery effect. Determining or estimating the color recovery may take into account the number of passes of the print head 104 over the printable substrate 102 to deposit the intended amount of colorant at each print addressable location. The color recovery may be represented as a function, referred to as a color recovery function. In some examples, the color recovery function may be approximated as a linear function and may therefore be represented by a value. In other examples, a more complex function may be used, taking into account parameters such as the number of print passes of the print head, for example.

A specific example of an algorithm that may be used when performing blocks of the methods 200, 300 is given below. The algorithm may be applied to each pixel of an image to be printed. In some examples, the algorithm may be applied in respect of each separate color of colorant to be used in the printing operation. For example, in a print apparatus in which cyan, yellow, magenta and black colorant is to be used, then the methods 200, 300 described herein, and the example algorithm given below, may be applied separately in respect of each colorant.

According to one example:

$${C}_{x}^{′} = \{ \begin{matrix}{C}_{x} , & {C}_{x} = 0 or E = 0 \\ {C}_{x} - E , & otherwise\end{matrix} \qquad [ 1 ]$$

where x is the current print addressable location, Cₓ is the initial colorant value (e.g. the contone value) at the print addressable location, C′ₓ is the adjusted colorant value at the print addressable location, and E is the color enrichment function, representing the color enrichment occurring in colorant in the nozzle as the nozzle reaches the current print addressable location x as a result of the nozzle not printing (i.e. remaining idle) for a period of time. Thus, if no colorant is to be deposited at the print addressable location, or if no color enrichment has occurred, then the colorant value remains unchanged; otherwise, the colorant value is adjusted by subtracting the color enrichment function.

$$E ( {C}_{x}^{′} , {D}_{x} ) = \{ \begin{matrix}min ( E ( {C}_{x}^{′} , {D}_{x - 1} ) + CEI ( {D}_{x} ) , MCEI ) , & {C}_{x} = 0 \\ max ( E ( {C}_{x}^{′} , {D}_{x - 1} ) + CR ( {C}_{x}^{′} ) , 0 ) , & otherwise\end{matrix} \qquad [ 2 ]$$

where x−1 is the print addressable location at which the nozzle deposited colorant immediately prior to reaching the current print addressable location x, CEI is the color enrichment increase function (or enrichment gain), MCEI is the maximum color enrichment increase (or maximum enrichment gain), and CR is the color recovery function. CEI, MCEI and CR may be determined empirically. According to expression [2], if no colorant is to be deposited at the print addressable location, then the colorant will continue to change as a result of color enrichment. Therefore, the color enrichment function, E, is the minimum of either (i) the previous color enrichment function plus the color enrichment increase function, or (ii) the maximum color enrichment increase. If print colorant is to be deposited at the print addressable location, then the color enrichment of colorant in the nozzle will reduce. Therefore, the color enrichment function is the maximum of (i) the previous color enrichment function plus the color recovery function (which may be negative), or (ii) zero.

The color enrichment increase function, CEI, and the color recovery function, CR, may be defined generally as follows:

CEI((C′ₓ),0)=β₀=β₁x+β₂x²+β₃x³+ . . . +βₙxⁿ+ε [3]

CR((C′ₓ),0)=β₀=β₁x+β₂x²+β₃x³+ . . . +βₙxⁿ+ε [4]

where β is any value. Expressions [3] and [4] represent generic polynomial formulae, the parameters of which may be obtained empirically, for example by printing and measuring specific diagnostic plots. For example, the color enrichment increase function CEI may be characterized by two parameters: a gain or slope in the color enrichment increase function, CEI and a saturation limit of the color enrichment (i.e. the maximum color enrichment increase, MCEI). The color recovery function CR may also be characterized as a slope or decrease. Since CEI and CR are determined through experimentation and measurements, they may also take into account characteristics of the print apparatus, details of a print mode used during printing operation and the composition of the colorant or print agent used. In some examples, other non-polynomial functions may be used for CEI and CR if they better fit the empirical enrichment and/or recovery of the color enrichment.

Since color enrichment may have a different impact for each different color of colorant, determining an adjustment to be made to the colorant value at each print addressable location may be performed for each color of colorant. When processing images to be printed, each color of colorant may be included in a separate plane, sometimes referred to as a color plane. Thus, when processing an image to be printed in order to determine whether and to what extent colorant values are to be adjusted to take account of the color enrichment effect discussed herein, each color plane may be processed individually. As discussed above with reference to the expressions [1] and [2], for each pixel or print addressable location, if the initial colorant value is equal to zero (indicating that colorant is not to be deposited at that print addressable location) and the maximum color enrichment increase MCEI is not reached, then the color enrichment increase function CEI is added to the color enrichment function E. Otherwise, if the initial colorant value is larger than zero, then the colorant value for that print addressable location is replaced by an adjusted colorant value, by subtracting the color enrichment function E from the initial colorant value. The adjusted colorant value may then be used to estimate the color recovery function, and the color recovery function (e.g. a negative function) may be added to the color enrichment function.

As is clear from the above example, and from the expressions given above, no adjustment may be made to a colorant value of a print addressable location where no colorant is to be delivered. Thus, the method 300 may comprise, responsive to obtaining data (at block 202) indicating that the colorant value for the first print addressable location is zero, determining that the adjustment to be applied to the colorant value for the first print addressable location is zero. Therefore, as a plane of print addressable locations is processed according to the methods 200, 300, adjustments may be made to colorant values at some print addressable locations while, at other print addressable locations, the colorant values may not be adjusted.

The method 300 may comprise, at block 308, providing the obtained data including the adjusted colorant value to a print apparatus to print the image. In some examples, a processor or processing apparatus of a print apparatus may perform the processing (e.g. blocks of the methods 200, 300) prior to performing the printing operation. In other examples, however, processing may be performed by a processor separate from or remote from the print apparatus, and the obtained data and adjusted colorant values may be provided in the form of modified image data, for example, for printing.

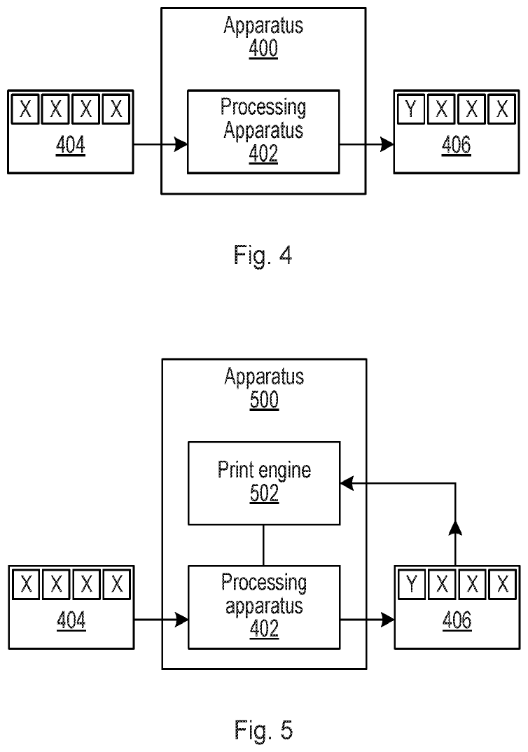

The present disclosure also provides an apparatus. FIG. 4 is a schematic illustration of an example of an apparatus 400. The apparatus 400 may be referred to as an apparatus for adjusting colorant values. The apparatus 400 comprises a processing apparatus 402. The processing apparatus (e.g. processing circuitry, a processor or multiple processors) 402 may perform one or more functions described in the blocks of methods 200, 300 discussed herein. According to some examples, the processing apparatus 402 is to receive image data 404 relating to continuous tone values (e.g. colorant values) for a plurality of print addressable locations. In some examples, the image data 404 may define the continuous tone values. In other examples, the image data may include other parameters, such as a number of passes of the print head 104 when depositing print agent at print addressable locations. The continuous tone values are representative of amounts of print agent to be delivered from a plurality of nozzles 106 of a print head 104 to the print addressable locations as the print head travels between the print addressable locations during a printing operation. The processing apparatus 402 is to determine, based on the image data 404, a duration that a nozzle of the plurality of nozzles is to remain idle prior to arriving at a particular print addressable location. The processing apparatus 402 is to determine, based on the duration, an adjustment to be applied to the continuous tone value at the particular print addressable location. The processing apparatus 402 is to apply the adjustment to obtain an adjusted continuous tone value for the particular print addressable location. Thus, the processing apparatus 402 may output adjusted image data 406.

In some examples, the processing apparatus 402 may determine the adjustment to be applied based on an estimated amount by which a color of print agent in the nozzle will vary as a result of the nozzle not delivering print agent for a particular duration. The estimated amount may comprise or be similar to the estimated color enrichment increase (block 302 of FIG. 3). As noted previously, the amount by which a color of print agent in the nozzle varies may reach a maximum, or threshold, after a threshold amount of time and, beyond the threshold amount of time, any further change of color may be negligible. Thus, in some examples, the processing apparatus 402 may determine the adjustment to be applied based further on a threshold amount of time beyond which a change in the color of the print agent as a result of the nozzle not delivering print agent is below a color change threshold.

The processing apparatus 402 may, in some examples, determine the adjustment to be applied based on an estimated amount by which the color of print agent in the nozzle will vary as a result of the nozzle delivering a particular amount of print agent. This estimated amount may comprise all be similar to be estimated color recovery effect (block 306 of FIG. 3).

The apparatus 400 may comprise a computing device, such as a desktop computer, laptop computer, a tablet computer, a smart phone or the like. In some examples, however, the apparatus may comprise a print apparatus.

FIG. 5 is a schematic illustration of a further example of an apparatus 500. The apparatus 500 may comprise a print apparatus. The apparatus 500 comprises the processing apparatus 402. In some examples, the apparatus 500 may further comprise a print engine 502 to print an image according to image data including the adjusted continuous tone value. For example, the processing apparatus 402 may provide the adjusted image data 406 the print engine 502 for printing.

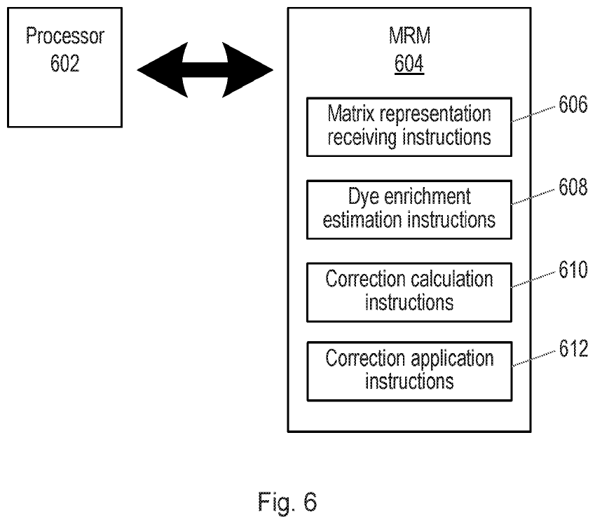

The present disclosure also provides a machine-readable medium. FIG. 6 is a schematic illustration of an example of a processor 602 in communication with a machine-readable medium 604. According to some examples, a machine-readable medium 604 comprises instructions which, when executed by a processor 602, cause the processor to perform various functions, such as those described in blocks of the methods 200, 300 discussed herein. In some examples, the machine-readable medium 604 comprises instructions (e.g. matrix representation receiving instructions 606) which, when executed by a processor 602, cause the processor to receive a matrix representation of a source image to be printed, the matrix representation defining an ink value for each of a plurality of print addressable locations in the matrix representation, wherein each ink value is representative of an amount of ink to be deposited from a print nozzle onto a print addressable location as the print nozzle moves between the print addressable locations during a printing operation. The ink value may comprise or be similar or equivalent to the contone value or colorant value discussed above. The machine-readable medium 604 may comprise instructions (e.g. dye enrichment estimation instructions 608) which, when executed by a processor 602, cause the processor to estimate, based on the received matrix representation, an amount of dye enrichment to occur in ink in a particular print nozzle as a result of the particular print nozzle remaining idle for a period of time prior to reaching a given print addressable location. The machine-readable medium 604 may comprise instructions (e.g. correction calculation instructions 610) which, when executed by a processor 602, cause the processor to calculate, based on the estimated amount, a correction to be applied to the ink value at the given print addressable location. The machine-readable medium 604 may comprise instructions (e.g. correction application instructions 612) which, when executed by a processor 602, cause the processor to apply the correction to the ink value for the given print addressable location.

In some examples, the machine-readable medium 604 may comprise instructions (e.g. matrix representation provision instructions) which, when executed by a processor 602, cause the processor to provide the matrix representation of the source image including the corrected ink value to a print apparatus to be printed.

The present disclosure provides a mechanism by which adjustments may be made to colorant values (e.g. contone values) in advance of a printing operation, in order to compensate for expected changes in the color of print agent as a result of print agent remaining in nozzles of a print head for a period of time before being deposited. By analyzing the image data relating to an image to be printed, is possible to estimate the so-called color enrichment at each print addressable location and make corresponding adjustments to the amount of print agent of each color that is to be deposited at each print addressable location. As a result, the image may be printed with the intended colors, and the likelihood of image quality defects in the printed image may be reduced.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
obtaining data defining colorant values for a plurality of print addressable locations representative of pixels of an image to be printed during a printing operation, wherein each colorant value is representative of an amount of colorant to be delivered from a print nozzle to a corresponding print addressable location as the print nozzle moves between the print addressable locations during the printing operation;
determining, based on the obtained data, a measure of time that the print nozzle is not to deposit colorant immediately prior reaching a first print addressable location;
determining, based on the determined measure of time, an adjustment to be applied to the colorant value at the first print addressable location; and
applying the adjustment to the colorant value for the first print addressable location.

2. A method according to claim 1, further comprising:
estimating a color enrichment increase in colorant in a print nozzle resulting from the print nozzle not depositing colorant for the determined measure of time;
wherein determining the adjustment is based further on the estimated color enrichment increase.

3. A method according to claim 2, further comprising:
determining a threshold measure of time beyond which the color enrichment increase in colorant in a print nozzle resulting from the print nozzle not depositing colorant is negligible;
wherein determining the adjustment is based further on the determined threshold measure of time.

4. A method according to claim 1, further comprising:
estimating a color recovery effect on colorant in a print nozzle resulting from colorant being deposited from the print nozzle;
wherein determining the adjustment is based further on the estimated color recovery effect.

5. A method according to claim 1, wherein, responsive to obtaining data indicating that the colorant value for the first print addressable location is zero, determining that the adjustment to be applied to the colorant value for the first print addressable location is zero.

6. A method according to claim 1, wherein the measure of time is to be determined based on: i) a distance between the first print addressable location and a second print addressable location at which the print nozzle is to deliver colorant immediately prior to reaching the first print addressable location, and ii) a speed at which the print nozzle is to move between the second print addressable location and the first print addressable location.

7. A method according to claim 1, further comprising:
providing the obtained data including the adjusted colorant value to a print apparatus to print the image.

8. A method according to claim 1, wherein the colorant values comprise continuous tone values.

9. An apparatus comprising:
a processing apparatus to:
receive image data relating to continuous tone values for a plurality of print addressable locations, wherein the continuous tone values are representative of amounts of print agent to be delivered from a plurality of nozzles of a print head to the print addressable locations as the print head travels between the print addressable locations during a printing operation;
determine, based on the image data, a duration that a nozzle of the plurality of nozzles is to remain idle prior to arriving at a particular print addressable location;
determine, based on the duration, an adjustment to be applied to the continuous tone value at the particular print addressable location; and
apply the adjustment to obtain an adjusted continuous tone value for the particular print addressable location.

10. An apparatus according to claim according to claim 9, wherein the processing apparatus is to determine the adjustment to be applied based on an estimated amount by which a color of print agent in the nozzle will vary as a result of the nozzle not delivering print agent for a particular duration.

11. An apparatus according to claim according to claim 10, wherein the processing apparatus is to determine the adjustment to be applied based further on a threshold amount of time beyond which the a change in the color of the print agent as a result of the nozzle not delivering print agent is below a color change threshold.

12. An apparatus according to claim according to claim 9, wherein the processing apparatus is to determine the adjustment to be applied based on an estimated amount by which the color of print agent in the nozzle will vary as a result of the nozzle delivering a particular amount of print agent.

13. An apparatus according to claim 9, further comprising:
a printing engine to:
print an image according to image data including the adjusted continuous tone value.

14. A machine-readable medium comprising instructions which, when executed by a processor, cause the processor to:
receive a matrix representation of a source image to be printed, the matrix representation defining an ink value for each of a plurality of print addressable locations in the matrix representation, wherein each ink value is representative of an amount of ink to be deposited from a print nozzle onto a print addressable location as the print nozzle moves between the print addressable locations during a printing operation;
estimate, based on the received matrix representation, an amount of dye enrichment to occur in ink in a particular print nozzle as a result of the particular print nozzle remaining idle for a period of time prior to reaching a given print addressable location;
calculate, based on the estimated amount, a correction to be applied to the ink value at the given print addressable location; and
apply the correction to the ink value for the given print addressable location.

15. A machine-readable medium according to claim 14, further comprising instructions which, when executed by a processor, cause the processor to:
provide the matrix representation of the source image including the corrected ink value to a print apparatus to be printed.
